(19) United States
(12) Patent Application Publication
(10) Pub. No.: US 2007/0204707 A1
(43) Pub. Date: Sep. 6, 2007

(54) PNEUMATIC ROTARY ACTUATOR

(76) Inventor: Giuseppe MAFFEIS, Roncadelle (Brescia) (IT)

Correspondence Address: MCGLEW & TUTTLE, PC, P.O. BOX 9227, SCARBOROUGH STATION, SCARBOROUGH, NY, 10510-9227, US

(21) Appl. No.: 11/678,260

(22) Filed: Feb. 23, 2007

(30) Foreign Application Priority Data
Feb. 28, 2006 (IT) BS 2006 A 000041

(51) Int. Cl. F16H 21/00

(52) U.S. Cl. 74/25

(57) ABSTRACT

The invention concerns a pneumatic control rotary actuator that incorporates a control piston of a rack toothing engaging with a pinion to cause it to rotate together with an item holder device; the pinion has toothing made up of several parallel pins (23) spaced at an angle, positioned and held orderly between a base flange (21) and an item holder disk head (22); the base flange and the disk are each produced by compression moulding, die-casting, sinterisation and the like, using a low mechanical resistance material whereas said pins are made of some other material with high mechanical properties and hardness.

### FIELD OF THE INVENTION

This invention concerns a pneumatically controlled rotary actuator for moving and orienting parts or components in mechanical operations, assembling and the like.

### State of the Technique

The type of pneumatically controlled rotary actuator taken into consideration comprises substantially a body forming a chamber and a housing with planes at right angles, with the chamber practically tangent to the housing, where a pneumatic piston subject to alternating movements is housed, and in said housing is also housed and supported a rotating cogged pinion with an item holder device, and where the piston has a rack cogged attachment designed to engage with the pinion to turn the latter together with the item holder device in response to the alternating movements of the piston.

According to the known technique, the cogged pinion for such an actuator is made out of a single piece through mechanical machining and precision cogs on machine tools.

Evidently, this machining procedure of the pinion necessitates considerable time and is costly, which are further increased if you consider that in order to ensure the required resistance under force and the wear on its cogs, the pinion must be made out of a material with very high mechanical properties and hardness, therefore in itself relatively precious and costly. More often also, the item holder device is an integral part of the pinion therefore it also has to be made of the same material as the pinion and machined at the same time.

According to the state of the technique, the construction of a pinion structure with, instead of the traditional radial cogs, has pins positioned and held between two head flanges and spaced at angles around a rotation axis, is also known, in that it was proposed by the same applicant. However, on the one hand, also in this case the flanges were made by machining items made of a high strength material such as steel, the same being valid for the pins but, on the other hand, such a pinion structure has never been used in rotary actuators.

### OBJECTIVES OF THE INVENTION

Starting from the above premises, one objective of the invention is to create the conditions so that a pneumatic rotary actuator of the type mentioned above can be made in a simpler and more economic way, at least by minimising times and costs of making and assembling some of its components, but nonetheless ensuring a high quality and reliable product.

Another objective of the invention is to propose a pinion which can be produced using simplified moulding techniques, without however having to turn to mechanical machining on machine tools or at least significantly limiting their use.

The task of the invention in fact, is to supply a pneumatically operated rotary actuator according to claim 1 and incorporating, therefore, a rotating pinion with “toothing” made up of several parallel pins, spaced at an angle, positioned and held between a base flange and an item holder disk head and where, however, said flange and cover or table are made of low strength and economic low-cost materials whereas the pins are made out of a hard high strength material.

Therefore and advantageously, on the one hand the base flange and the pinion head can be made using moulding techniques, such as compression moulding, die-casting, sinterisation and the like, using initial low-cost materials such as zama (Zn+AL+Mg alloy) whereas the pins can be made out of a material with very high mechanical performance such as steel.

The abovementioned moulding techniques can be used to produce finished articles even with relatively complicated shapes, with minimum tolerances, with a high degree of precision, and with the possibility of using surface treatment, where required, so that the base flange and pinion head do not require further intervention and mechanical machining. In other words, the base flange and cover or head can be relatively easily produced at a limited cost, but they cannot be integrated with traditional cog connections made of the same material, in that they would not, in this case, have sufficiently reliable strength for use under force. Whereas, although made of a low-cost material with low mechanical properties, they are part of the assembly of the pins which, being made of a material with high mechanical properties, guarantee the required mechanical strength and wear resistance in coupling with a complementary means, such as the rack of the control piston in the range of a rotary actuator.

### BRIEF DESCRIPTION OF THE DRAWINGS

The invention will however be illustrated more in detail in the continuation of this description made in reference to the enclosed indicative and not restrictive drawings, in which:

FIG. 1 shows a view in perspective of the assembled rotary actuator;

FIG. 2 shows a blow-up of its components;

FIGS. 3 and 4 show a blow-up from two different directions of the pinion components.

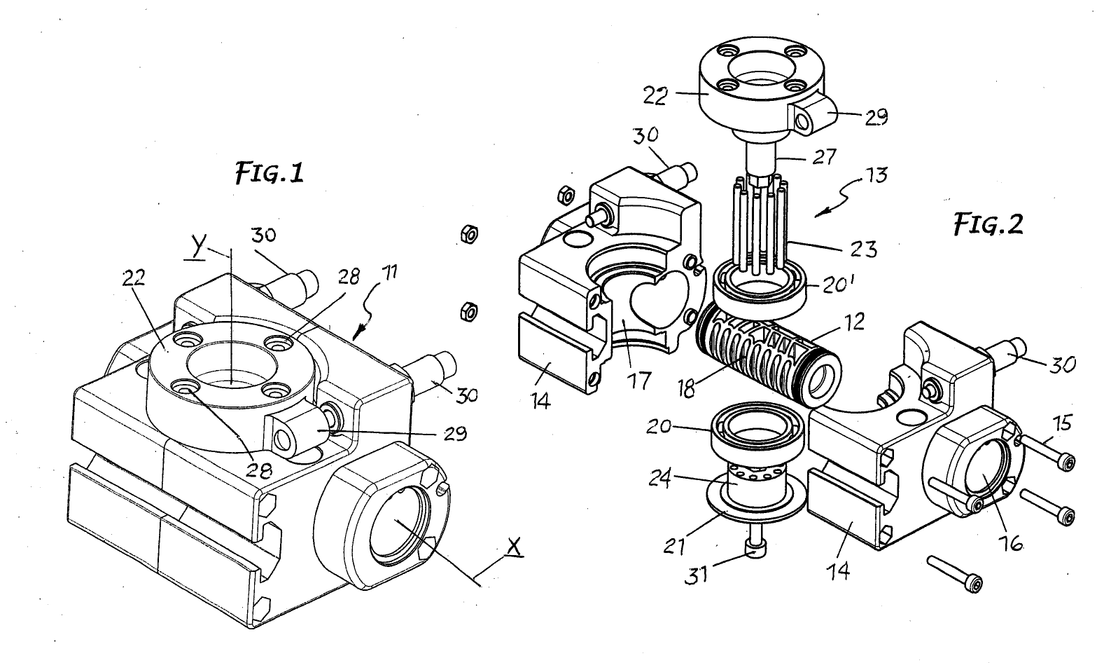

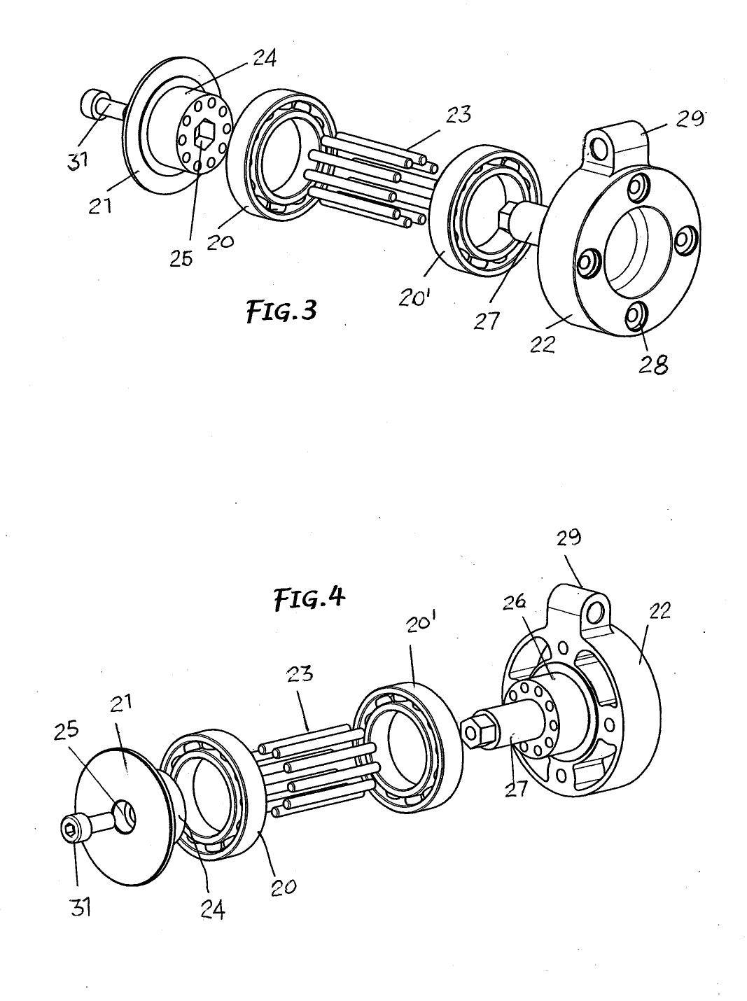

### DETAILED DESCRIPTION OF THE INVENTION

As shown, the rotary actuator under examination basically comprises a body 11, a control piston 12 and a pinion 13.

The body 11 can be made out of a single piece or, better, as shown in FIG. 2, out of two complementary opposed elements 14, coupled and fixed together by screws 14, 15. In any case, the body 11, whether single or made up of two elements, forms a chamber 16 which extends according to an X axis and a housing 17 with a Y axis at a right angle to the X axis of the chamber, the latter being basically tangent and crossing the housing 17.

The piston 12 has, on one side, a rack 18, it is housed in a chamber 16 and moves by reciprocating motion, driven by a fluid, usually compressed air, delivered to said chamber alternatively from opposite sides of the piston.

The pinion 13 is housed and rotates in said housing 17 with the interposition of support bearings 20, 20′ and it engages with the rack of the piston 12.

The pinion 13 comprises a base flange 21, an item holder disk head 22 and a number of pins 23, that extend between the base flange and the cover or table disk and which acts as toothing for the pinion to engage with the rack attachment of the piston.

The base flange and the cover or disk are produced by compression moulding, die-casting, sinterisation and the like, using low-cost materials such as zama (Zn+AL+Mg alloy) which are economic and with low mechanical properties. In particular, the base flange 21 is integral with a neck 24 designed to receive a first support bearing 20 and provided with a central bore 25.

The disk head 22 also has a neck 26 designed to receive a second support bearing 20′ and an axial shank 27 designed to fit into the central bore 25 of the base flange 21. On the front face of both the neck 24 of the base flange, and the neck 26 of the disk head 22 are provided bores positioned according to the circumference, in which the ends of the pins 23 acting as toothing on the pinion are housed and held.

Furthermore it should be noted that the disk head 22 can also be provided with bores 28 so as to be able to attach at least an item holder device—not shown—and an integral radial wing 29 acting as a guide designed to work with end of stroke elements 30 associated with the body to be carried out.

Prior to assembling each bearing on respective neck, the components 21, 22, 23 of the pinion 13 are coupled and assembled in the direction of the axis and then fixed to each other by a screw 31 designed to block the end of the axial shank 27 of the disk head 22 in the central bore 25 of the base flange 21. Once assembled, the pinion is mounted in its housing 17 formed by the body of the actuator 11, matching the pins 23 with the rack 18 of the piston so that the disk head 22 projects over the body with the possibility of turning depending on the stroke of the piston and angle set by the end of stroke element 30.

1. Pneumatically controlled rotary actuator comprising an actuator body forming a chamber and a housing with orthogonal planes and with the chamber tangent to the housing, where a pneumatic piston, subject to alternating movements is housed, where said housing also houses and supports a turning pinion bearing an item holder disk head, and where the piston has a toothed rack engaging with the pinion to make it turn together with the item holder disk head in response to the alternating movements of the piston, wherein said pinion has a toothing formed of parallel pins, at intervals at an angle, positioned and engaging and held in an orderly way between a base flange and said item holder disk head and wherein said flange and disk are made of a first poor material with low mechanical strength, and said pins are made of a second material with high mechanical properties and hardness.

2. Pneumatic rotary actuator according to claim 1, in which the base flange has an integral necks, designed to receive a first support bearing, and an axial through bore; in which the item holder disk head has a neck designed to receive a second support bearing, and an axial shank with one end housed in said axial bore of the base flange; and in which the opposed facing sides of the neck of the base flange and the neck of the item holder disk head each have orderly bores following a circumference designed to receive and hold the ends of said pin forming the toothing of the pinion.

3. Pneumatic rotary actuator according to claim 1, in which said base flange, said pins and said item holder disk head forming the pinion are coupled and fixed longitudinally.

4. Pneumatic rotary actuator according to claim 3, in which in said base flange, said pins and said item holder disk head are fixed longitudinally with a screw blocking the end of the axial shrank of the disk head in the central bore of the base flange.

5. A pneumatic rotary actuator according to claim 1, in which in said base flange, and said item holder disk head of the pinion are each made of a material such as zama (Zn+AL+Mg alloy) or another low mechanical resistance material, and produced using compression moulding, die-casting, sinterisation and the like, and said pins are steel or some other material with high mechanical properties and hardness.

6. A pneumatic rotary actuator according to claim 1, in which the disk head has an integral lateral wing acting as a guide for an end of stroke element, e bores provided directly during the moulding process and designed for attaching complementary elements.

7. A pneumatic rotary actuator according to claim 1, in which the pinion made up of the pins positioned and held between the base flange and item holder disk head is inserted as a whole with the support bearings in the housing of the actuator body so that said pins engage with the toothing of the pneumatic piston and said disk head protrudes from said body.

8. A pneumatic rotary actuator according to claim 1, in which the body of the actuator is either in one piece or made up of two elements which are complementary and assembled to form said chamber for the piston and said housing for the pinion.
